(19) United States
(12) Patent Application Publication
(10) Pub. No.: US 2025/0180056 A1
(43) Pub. Date: Jun. 5, 2025

(54) Closure Device for Connecting Two Assemblies

(71) Applicant: Fidlock GmbH, Hannover (DE)

(72) Inventors: Florian Hüwel, Hannover (DE); Joachim Fiedler, Hannover (DE)

(21) Appl. No.: 18/841,763

(22) PCT Filed: Dec. 12, 2022
(86) PCT No.: PCT/EP2022/085412

§ 371 Date: Aug. 27, 2024

(30) Foreign Application Priority Data
Feb. 28, 2022 (DE) 10 2022 104 733.4

(51) Int. Cl. F16B 21/02; B62J 9/27; B62J 11/00; B62J 43/20

(52) U.S. Cl. CPC F16B 21/02; B62J 9/27; B62J 11/00; B62J 43/20; F16B 2200/83

(57) ABSTRACT

A closure device for connecting two assemblies to each other includes a first closure part associated to a first one of the assemblies, which includes a housing part, a plug opening arranged on the housing part, at least one first engaging protrusion and an adjusting element adjustably arranged on the housing part. The closure device also includes a second closure part associated to a second one of the assemblies, which includes an engaging element with at least one second engaging protrusion. The plug opening, as seen along a plane perpendicular to the closing direction, is delimited by at least one boundary portion in such a way that for closing the closure device the engaging element can be inserted into a space delimited by the at least one boundary portion.

### CROSS-REFERENCE TO A RELATED APPLICATION

This application is the United States national phase of International Patent Application No. PCT/EP2022/085412, filed on Dec. 12, 2022, and claims priority to German Patent Application No. 10 2022 104 733.4, filed on Feb. 28, 2022, the disclosures of which are hereby incorporated by reference in their entireties.

### BACKGROUND

### Technical Field

This solution relates to a closure device for connecting two assemblies to each other.

### Technical Considerations

Such a closure device comprises a first closure part associated to a first one of the assemblies, which includes a housing part, a plug opening arranged on the housing part, at least one first engaging protrusion and an adjusting element adjustably arranged on the housing part. The closure device also comprises a second closure part associated to a second one of the assemblies, which includes an engaging element with at least one second engaging protrusion. For closing the closure device, the engaging element can be inserted into the plug opening along a closing direction. In a closed position, the at least one first engaging protrusion is in engagement with the at least one second engaging protrusion for holding the first closure part and the second closure part at each other against the closing direction. For opening the closure device, the first closure part and the second closure part can be separated from each other.

In the closed position, a reliable, firm, loadable hold of the closure parts at each other is to be produced via such a closure device in order to connect the assemblies associated to the closure parts to each other and mechanically hold the same at each other. The closure device should be easy to handle in that the closure device can be comfortably closed and also be comfortably opened again.

Such a closure device can be used for example on a vehicle, for example a motor vehicle or a bicycle, in order to connect assemblies to each other. For example, such a closure device can serve to mount an assembly on a bicycle frame.

In the closure device it is desirable for example that in the closed position closure parts are held at each other in a vibration-resistant and rattle-free way, wherein it should be taken into account that mechanical manufacturing tolerances can exist. In operation, a firm, substantially clearance-free connection of the closure parts relative to each other should be created for an increased user feeling.

In a closure device known from DE 10 2018 123 026 A1 closure parts are attached to closure elements, which are arranged on a base body, in order to close the closure device. On the closure elements and the closure parts blocking portions are arranged, which in the closed position of the closure device mechanically are in engagement with each other and produce a positive connection. The closure device of DE 10 2018 123 026 A1 for example implements a closure for belts of a pram or a child seat.

WO 2020/216955 A1 describes a closure device for connecting two assemblies to each other, which includes a first closure part with a blocking piece and a first magnetic element and a second closure part with a blocking receptacle and a second magnetic element. In addition, the closure device includes a locking mechanism arranged on the second closure part, which includes a locking element and an actuating mechanism operatively connected to the locking element, wherein in a closed position the locking element can be operatively connected to the blocking piece in order to block a positive engagement between blocking portions of the first closure part and of the second closure part.

WO 2010/084191 A1 describes a closure device in which a connecting module with a blocking piece can be attached to a spring locking element of a further connecting module. The spring locking element here is rotatably arranged on the further connecting module in such a way that by rotating the spring locking element opening of the closure device can be blocked.

### SUMMARY

Accordingly, provided is an improved closure device which is easy to handle and in a closed position provides for a reliable, loadable, rather clearance-free hold of the closure parts at each other.

Accordingly, the plug opening, as seen along a plane perpendicular to the closing direction, is delimited by at least one boundary portion in such a way that for closing the closure device the engaging element can be inserted into a space delimited by the at least one boundary portion. In the first position, an acting portion of the adjusting element is arranged outside the space in order to provide for an insertion of the engaging element into the space. When the first closure part and the second closure part are attached to each other, the adjusting element can be transferred from the first position into the second position so that in the second position the acting portion, as seen along the plane perpendicular to the closing direction, is arranged within the space in order to produce or secure the engagement between the at least one first engaging protrusion and the at least one second engaging protrusion for holding the first closure part and the second closure part at each other against the closing direction.

The closure device includes two closure parts which can be attached to each other along the closing direction for closing the closure device. The closure device here can be configured as a purely mechanical closure device, in which the closure parts are mechanically held at each other in the closed position by mechanical engagement of the closure parts. The closure device can, however, also be configured as a mechanical-magnetic closure device, in which the closure parts are magnetically drawn towards each other for closing along the closing direction and in the closed position preferably are held at each other both mechanically and magnetically.

The first closure part includes a housing part, at least one first engaging protrusion and an adjusting element adjustably arranged on the housing part. The second closure part on the other hand includes an engaging element with at least one second engaging protrusion. In the closed position, the engaging protrusions are in engagement with each other in such a way that the closure parts are held at each other against the closing direction.

The plug opening, as seen along a plane perpendicular to the closing direction, is delimited by at least one boundary portion so that a space is formed within the plug opening, into which the engaging element can be inserted for closing the closure device. The boundary portion can be formed for example by a circumferential, for example circular edge defining the plug opening. Boundary portions can, however, also be formed by one or more protrusions which radially protrude to the inside from a circumferential edge and thus specify a space into which the engaging element can be inserted for closing the closure device. For example, two boundary portions facing each other delimit the space, wherein the engaging element can be inserted between the boundary portions facing each other for closing the closure device.

The space is formed in a projection plane perpendicular to the closing direction. The engaging element can be inserted into the space in the closing direction in order to produce or secure an engagement between the engaging protrusions after the insertion by rotating the adjusting element on the housing part of the first closure part.

The adjusting element here includes an acting portion which in the first position of the adjusting element is arranged outside the space and thus no longer limits the space available for inserting the engaging element. In the first position of the adjusting element the acting portion thus does not prevent an insertion of the engaging element into the space formed within the plug opening.

To produce or secure the engagement between the engaging protrusions, the adjusting element can be rotated from the first position into the second position after insertion of the engaging element into the plug opening, whereby the engaging element is fixed within the plug opening. In the second position, the acting portion is disposed radially within the space and thus is operatively connected to the engaging element so that the adjusting element acts on the engaging element for producing the connection or at least acts on the engaging element such that the engagement of the engaging protrusions is secured.

In a non-limiting embodiment, the space formed within the plug opening includes a center. The adjusting element is rotatable relative to the housing part of the first closure part between the first position and the second position about an axis of rotation eccentric to the center. The adjusting element in the second position is configured produce or at least secure the engagement between the at least one first engaging protrusion and the at least one second engaging protrusion via the acting portion for holding the first closure part and the second closure part at each other against the closing direction. The adjusting element is eccentrically rotatable relative to the plug opening on the housing part of the first closure part. In the first position, the adjusting element provides for an attachment of the closure parts to each other along the closing direction. In the second position, the adjusting element is rotated on the housing part in such a way that by action of the acting portion on the engaging element the engagement between the engaging protrusions is produced or at least secured and the closure parts thus are held at each other along the closing direction.

When the space is delimited by two boundary portions facing each other, the center is located centrally between the boundary portions. When the space is delimited by the circular opening (as seen in a plane perpendicular to the closing direction) of the plug opening, the center is defined by the center of the circular opening. In general, the center is defined by the point which is located in the geometrical center of the region into which the engaging element can be inserted for closing the closure device.

The at least one first engaging protrusion can be arranged on the adjusting element, for example on a collar portion of the adjusting element. In this case, the acting portion is formed by the engaging protrusion which on adjustment of the adjusting element is rotated into the space and thus is brought in engagement with the engaging protrusion on the engaging element, so as to produce the connection between the closure parts.

The at least one first engaging protrusion can, however, also be arranged for example on the housing part, wherein on rotation of the adjusting element into the second position the engaging element of the second closure part with the at least one second engaging protrusion arranged thereon is moved into engagement with the at least one first engaging protrusion on the housing part of the first closure part or the engagement of the engaging protrusions is at least secured. In this case, the acting portion is formed for example by a collar portion of the adjusting element, which on adjustment of the adjusting element is operatively connected to the engaging element and thereby urges the engaging element transversely to the closing direction into engagement with the engaging protrusion on the housing part or at least blocks the engaging element such that the engaging protrusions cannot get out of engagement. The acting portion formed by a collar portion in this case for example can have a wedge shape. When the adjusting element is rotated, the acting portion runs up onto the engaging element and thereby urges the engaging element transversely to the closing direction so that the engaging protrusion of the engaging element comes into engagement with the engaging protrusion on the housing part. When the engaging protrusions have already come into engagement for example by magnetic interaction without any action of the adjusting element, the adjusting element at least can block the engaging element with the collar portion such that the engagement of the engaging protrusions is secured.

In a non-limiting embodiment, the adjusting element includes a base and a collar portion rigidly formed on the base, which protrudes from the base along the closing direction. The base forms a body of the adjusting element and for example can provide a surface extended substantially perpendicularly to the closing direction, which in the closed position provides an abutment surface for the engaging element of the second closure part. The collar portion protrudes from the base along the closing direction and for example can provide a circumferentially closed wall or also a wall circumferentially open in the manner of a C-ring on the base, within which the engaging element of the second closure part is received in the closed position.

Via the collar portion, a receptacle can be created for the engaging element. In the second position of the adjusting element, opening of the closure device by a relative movement of the closure parts can be blocked for example via the collar portion in a plane perpendicular to the closing direction, so that in the second position opening of the closure device is prevented via the adjusting element and the closure device can only be opened when the adjusting element on the first closure part has been moved back into the first position.

The collar portion for example can form the acting portion and for example be designed such that on rotation of the adjusting element on the housing part from the first position into the second position the collar portion acts on the engaging element and urges the same transversely to the closing direction into engagement with an engaging protrusion on the housing part.

In a non-limiting embodiment, the collar portion can provide a guide surface via which the engaging element is guided along the closing direction on insertion into the plug opening. In the first position of the adjusting element, the collar portion for example can be arranged in alignment with the plug opening such that the engaging element is inserted into the plug opening and is guided along the closing direction on the collar portion, so that the engaging element can be introduced into the plug opening in a reliable, comfortable way.

The engaging element of the second closure part is formed for example by a rigid trunnion. The at least one second engaging protrusion here radially protrudes from the trunnion in order to produce a connection between the closure parts in the closed position by engagement with the at least one first engaging protrusion of the first closure part.

In a non-limiting embodiment, the at least one first engaging protrusion is arranged on the collar portion. The engaging protrusion here preferably is rigidly formed on the collar portion. The collar portion likewise is of rigid design and connected to the rigid base so that the adjusting element on the whole is formed as a substantially rigid part which is not elastically deformable when loaded properly.

In a non-limiting embodiment, the at least one first engaging protrusion protrudes from the collar portion transversely to the closing direction and preferably extends radially to the inside in order to produce a connection between the closure parts in the closed position via the engagement with the at least one second engaging protrusion of the engaging element of the second closure part.

The at least one first engaging protrusion and the at least one second engaging protrusion preferably each form an undercut. The undercut here is not necessarily formed by surfaces directed perpendicularly to the closing direction. Surfaces of the undercut rather can also be extended obliquely to the closing direction. The undercut of the respective engaging protrusion is formed in that the engaging protrusion protrudes transversely to the closing direction and by engagement of the engaging protrusions into each other a movement of the closure parts along the closing direction is blocked, so that in the closed position of the closure device the closure parts are held at each other along the closing direction-possibly under an additional blocking effect of a blocking element.

In the closed position, the at least one first engaging protrusion and the at least one second engaging protrusion preferably are positively in engagement with each other. Holding the closure parts at each other thus is effected due to the shape of the engaging protrusions. The positive connection here can be produced solely via the engaging protrusions. In another embodiment, the positive connection can, however, also be effected by engagement of the engaging protrusions and an additional blocking effect, for example via the adjusting element, in such a way that the engaging protrusions can slide off from each other along the closing direction after elimination of the blocking effect.

In a non-limiting embodiment, the plug opening is formed by a circular opening on a side of the housing part to which the second closure part is attached for closing the closure device. The center of the plug opening generally corresponds to the (geometrically determined) center of the plug opening. When the engaging element is inserted into the plug opening, the engaging element (for example of rotationally symmetrical shape) is concentrically received in the plug opening.

In a non-limiting embodiment, the housing part can include a bearing opening for rotatably supporting the adjusting element on the housing part about the axis of rotation. The adjusting element is received in the bearing opening and rotatable on the housing part about the associated axis of rotation eccentric with respect to the center of the plug opening.

Via the eccentrically adjustable adjusting element the connection between the closure parts is produced. When the at least one first engaging protrusion is arranged on the adjusting element, for example on a collar portion of the adjusting element connected to a base, the at least one first engaging protrusion—in a non-limiting embodiment—in the first position, as seen along a plane perpendicular to the axis of rotation, is arranged outside the plug opening. In the first position, an insertion of the engaging element of the second closure part into the plug opening of the first closure part thus is possible. In the second position, the at least one first engaging protrusion on the other hand protrudes into the region of the plug opening and thereby is in engagement with the at least one second engaging protrusion on the engaging element of the second closure part, so that in the second position the closure parts are held at each other along the closing direction. Due to the eccentric rotation of the adjusting element on the housing part of the first closure part, the engaging protrusion thus is moved relative to the plug opening, so that in the first position of the adjusting element an insertion of the engaging element of the second closure part into the plug opening becomes possible, but in the second position due to the protrusion into the region of the plug opening the engagement between the closure parts is produced and the closure parts thus are fixed relative to each other.

The adjustment of the adjusting element from the first position into the second position for example can be effected manually by a user. On closing of the closure device, the adjusting element on the first closure part preferably is disposed in the first position. When the closure parts have been attached to each other, the user transfers the adjusting element from the first position into the second position in order to thereby pretension the closure parts relative to each other along the closing direction. This results in a two-stage closing process, in which the closure parts initially are attached to each other by the user and, after attachment, the adjusting element on the first closure part is adjusted in order to complete the connection between the closure parts.

The adjustment of the adjusting element from the first position into the second position can, however, also be effected automatically in that the adjusting element on the housing part of the first closure part for example is spring-biased in the direction of the second position and on attachment of the closure parts to each other the adjusting element is released so that the adjusting element automatically moves from the first position into the second position.

In a non-limiting embodiment, the first closure part and the second closure part can be attached to each other for closing the closure device exclusively in the first position of the adjusting element. Thus, the adjusting element must be brought into the first position on the first closure part in order to provide for an attachment of the closure parts to each other. By transferring the adjusting element on the first closure part from the first position into the second position, the connection between the closure parts then is completed in that in the second position a pretension between the closure parts is effected along the closing direction via the adjusting element and opening of the closure device preferably also is blocked.

In another embodiment, an attachment of the closure parts can however also be possible in the second position of the adjusting element. In this case, the adjusting element for example can entirely or with a portion be of elastic design, in order to yield transversely to the closing direction on attachment of the closure parts to each other and thus provide for an attachment of the closure parts to each other.

In a non-limiting embodiment, the adjusting element in the second position is configured to exert a pretensioning force on the engaging element along the closing direction. The adjusting element on the housing part can be brought into a first position in which an attachment of the closure parts to each other is possible. When the closure parts have been attached to each other, the adjusting element can be adjusted on the first closure part in order to thereby effect a pretensioning force between the closure parts, which acts along the closing direction and thus pretensions the closure part relative to each other along the closing direction.

In particular, by providing a pretensioning force, a substantially clearance-free, rattle-free hold of the closure parts at each other can be effected in the closed position. Due to the fact that in the second position the closure parts are pretensioned relative to each other along the closing direction via the adjusting element, it can be effected that an axial clearance directed along the closing direction, which for example is due to manufacturing tolerances, is compensated and the closure parts are held at each other along the closing direction firmly and substantially without any clearance. In operation of the closure device, the hold of the closure parts at each other can be improved in this way, wherein in particular a susceptibility to vibrations can be suppressed.

The adjusting element preferably is rotatable relative to the housing part about an axis of rotation pointing along (parallel to) the closing direction. In the first position, the adjusting element takes a first rotary position on the housing part. In the second position, the adjusting element is rotated on the housing part in order to effect a pretension between the closure parts along the closing direction in the second position.

In a non-limiting embodiment, the adjusting element is axially adjustable on the housing part (in addition to the rotatability). In the first position, the adjusting element here takes a first axial position relative to the housing part, and in the second position takes a second axial position relative to the housing part, which is different from the first axial position and offset along the closing direction. By adjusting the adjusting element on the housing part, the adjusting element thus is axially adjusted on the housing part along the closing direction in order to thereby effect a pretension between the closure parts. By axially adjusting the adjusting element, the adjusting element for example can effect a pulling action or a pressing action on the engaging element of the second closure part along the closing direction so as to provide a pretension between the closure parts.

For example, the adjusting element can effect a pulling action in the closing direction on the engaging element. When at least one first engaging protrusion formed on the adjusting element is in engagement with the at least one second engaging protrusion on the engaging element, a pulling action can be effected on the engaging element during an axial adjustment of the adjusting element on the housing part of the first closure part in the closing direction, so that the engaging element is pulled (further) in the closing direction into engagement with an associated plug opening on the housing part of the first closure part.

Alternatively, there can also be effected a pretension on the engaging element against the closing direction. For example, the adjusting element can effect a pressing action against the closing direction on the engaging element. For this purpose, the engaging element for example can press onto the engaging element with its base. When on adjustment from the first position into the second position the engaging element is axially adjusted against the closing direction on the housing part of the first closure part, the engaging element presses onto the engaging element with its base and thus pretensions the same relative to the housing part against the closing direction.

In a non-limiting embodiment, the first closure part includes a run-up element with a first frame portion arranged on the housing part and the adjusting element includes a run-up portion with a second frame portion. During an adjustment of the adjusting element for axially adjusting the adjusting element the first frame portion slides on the second frame portion. When the adjusting element is adjusted, for example rotated, on the housing part of the first closure part, the adjusting element with its run-up portion thus runs up onto the run-up element on the housing part so that an axial adjustment of the adjusting element thereby is effected on the housing part, so as to effect an axial pretension between the closure parts on transfer into the second position.

The run-up element preferably is non-rotatably connected to the housing part. The run-up element can be integrally formed on the housing part or be attached to the housing part as a separate element, wherein during an adjustment of the adjusting element the run-up element is moved relative to the housing part, but not in the adjustment direction, but remains non-rotatably connected to the housing part.

In a non-limiting embodiment, the first closure part and/or the second closure part include an elasticity element elastically deformable along the closing direction. When the elasticity element is arranged on the first closure part, the run-up element for example is supported relative to the housing part for example along the closing direction via the elasticity element. The elasticity element here is elastically braced during an adjustment of the adjusting element, so that an elastic pretensioning force thereby is effected between the closure parts. By transferring into the second position, the adjusting element can load the engaging element of the second closure part for example in the closing direction towards an engagement with a slot on the first closure part, whereby the elasticity element is elastically deformed and thus braced and an elastic pretensioning force thereby is provided between the closure parts.

The elasticity element can be formed for example by an element formed of an elastomeric material, for example in the form of an O-ring. In another embodiment, the elasticity element can be formed for example by a mechanical spring element, for example made of a spring steel or a plastic material, for example as a disc spring.

The elasticity element can be formed as a separate element or can be formed integrally with the run-up element or the housing part or also with a housing of the second closure part.

In a non-limiting embodiment, the first closure part includes an actuating element which can be actuated in order to adjust the adjusting element between the first position and the second position. The actuating element for example can be linearly movable along the actuating direction to the housing part and thus is formed in the manner of a slide or pusher which can be linearly adjusted by a user. Via the actuating element, an adjustment of the adjusting element on the housing part can be effected in that a user manually actuates the actuating element and, after attachment of the closure parts to each other, thereby transfers the adjusting element from the first position into the second position or, vice versa, transfers the adjusting element from the second position into the first position for releasing the closure device.

In a non-limiting embodiment, the first closure part includes a drive element operatively connected to the adjusting element, which is configured to introduce an adjusting force into the adjusting element on actuation. The drive element can be provided in addition to the actuating element. The drive element can, however, also be provided without an additional actuating element and for example can be manually actuatable by a user in that a user can act on the drive element in order to thereby introduce an adjusting force into the adjusting element, in particular in order to transfer the adjusting element from the first position into the second position or vice versa from the second position into the first position.

The drive element for example can be rotatably arranged on the housing part of the first closure part. The drive element can be configured for example in the manner of a gear wheel which is in meshing engagement with the adjusting element so that a rotary movement of the drive element is introduced into the adjusting element and the adjusting element thereby is moved between the first position and the second position.

In a non-limiting embodiment, the drive element includes a first toothing portion which is in meshing engagement with a toothing portion of the actuating element. In this case an additional actuating element thus is provided, which can be actuated in order to adjust the drive element. The actuating element is in meshing engagement with the drive element so that during a (linear) movement of the actuating element the drive element is rotated on the housing part.

In a non-limiting embodiment, the drive element-additionally or alternatively to the first toothing portion-includes a second toothing portion which is in meshing engagement with a toothing portion of the adjusting element. An adjusting force thus is introduced into the adjusting element via the meshing engagement of the second toothing portion with the toothing portion of the adjusting element, so that during a (rotary) movement of the drive element the adjusting element is adjusted on the housing part.

On the actuating element and/or on the drive element a status display can be arranged, which indicates to a user in what position the adjusting element is disposed. With reference to the status display, a user thus can recognize directly whether the adjusting element has been transferred from the first position into the second position for closing the closure device and closing of the closure device thus has been completed. The status display can be provided for example by a colored or some other marking on the actuating element or the drive element.

For example, at a position of the actuating element which is associated to the first position of the adjusting element a colored (e.g. red) marking can be indicated to a user. After actuation of the actuating element for transferring the adjusting element into the second position, the marking on the other hand no longer is visible so that a user can directly recognize that the closing of the closure device has been effected correctly and is completed.

The engaging element of the second closure part can be inserted into the plug opening along the closing direction for closing the closure device. The plug opening defines a slot for receiving the engaging element of the second closure part. On attachment of the closure parts to each other, the engaging element of the second closure part comes into engagement with the plug opening on the housing part of the first closure part, whereby the engaging protrusions come into engagement with each other and thus a connection between the closure parts is produced.

The closing of the closure device in principle is effected by attaching the closure parts to each other along the closing direction, wherein an attachment of the closure parts can also be possible in a direction deviating from the closing direction, for example along a direction extended obliquely to the closing direction. In a magnetically formed closure device, a force of magnetic attraction acts between the closure parts substantially along the closing direction, so that the closure parts are drawn towards each other along the closing direction.

The opening of the closure device can be effected by removing the closure parts from each other against the closing direction. In another embodiment, the opening of the closure device can, however, also be effected by a relative movement of the closure parts in a plane directed perpendicularly to the closing direction.

The closure device can be configured as a purely mechanical closure device. The closure device can, however, also be designed as a mechanical-magnetic closure device with magnetic elements.

In a non-limiting embodiment, the first closure part includes a first magnetic element and the second closure part includes a second magnetic element, wherein the first magnetic element and the second magnetic element cooperate in a magnetically attracting manner in order to magnetically support the attachment of the first closure part and the second closure part for closing the closure device along the closing direction. The magnetic elements act in a magnetically attracting manner along the closing direction and thus on attachment draw the closure parts towards each other along the closing direction so that the closing of the closure device is magnetically supported.

The magnetic elements of the closure parts can each be formed by a permanent magnet. Alternatively, one of the magnetic elements can be formed by a permanent magnet and the other one of the magnetic elements can be formed by a ferromagnetic armature.

The magnetic element of the first closure part can be arranged on the housing part or on the adjusting element. The magnetic element of the second closure part can be arranged for example on the engaging element of the second closure part.

In a non-limiting embodiment, the first closure part includes two slots each with at least one first engaging protrusion and an adjusting element adjustable relative to the housing part. The second closure part on the other hand includes two engaging elements each with at least one second engaging protrusion. For closing the closure device, each of the engaging elements of the second closure part can be attached to one of the slots of the first closure part. In the closed position, the first engaging protrusions are in engagement with the second engaging protrusions for holding the first closure part and the second closure part at each other against the closing direction. Thus, there is provided a closure device with (at least) two slots on the first closure part so that a connection between the closure parts is effected by engagement of two engaging elements of the second closure part on slots of the first closure part.

Here, the adjusting elements for example are arranged on the housing part of the first closure part so as to be adjustable between a first position and a second position. The adjusting elements each are mounted eccentrically relative to a center of an associated plug opening and thus can be eccentrically rotated relative to the plug openings on the housing part. In the second position, the adjusting elements produce the engagement between the first engaging protrusions and the second engaging protrusions for holding the first closure part and the second closure part at each other against the closing direction.

The adjusting elements in the second position each are configured to each exert a pretensioning force on an associated one of the engaging elements along the closing direction. Via the adjusting elements a pretension hence is effected at the engaging elements so that the closure parts are pretensioned relative to each other along the engagement direction.

In a non-limiting embodiment, the adjusting elements are jointly and preferably synchronously adjustable at the slots of the first closure part via an actuating mechanism of the first closure part. The actuating mechanism for example can include a drive element, for example in the form of a gear wheel. On actuation of the drive element, the adjusting elements are jointly adjusted.

In another embodiment, the adjusting elements also can be adjustable independently of each other, for example in that a user can independently act on each adjusting element in order to adjust the respective adjusting element, without the other adjusting element also being adjusted.

In a non-limiting embodiment, one of the closure parts includes a bearing pin and the other one of the closure parts includes an engagement opening. In the closed position, the bearing pin engages into the engagement opening and thereby supports the first closure part and the second closure part on each other. Via the engagement of the bearing pin with the engagement opening, a support of the closure parts can be provided in a plane perpendicular to the closing direction.

In a non-limiting embodiment, the first closure part includes a first electrical contact arrangement and the second closure part includes a second electrical contact arrangement. In the closed position, the first electrical contact arrangement and the second electrical contact arrangement are operatively connected to each other in an electrically contacting way so that an electrical connection is produced between the contact arrangements when the closure device is disposed in its closed position.

Each contact arrangement can include one, two or more electrical contacts, for example three contacts, four contacts or seven contacts or also another number of contacts. The closure device thus acts as an electrical closure device via which in the closed position an electrical connection between the associated assemblies is produced.

The closure device can serve for connecting two assemblies of a vehicle, for example of a motor vehicle or a bicycle, for example of an electric bicycle (e-bike).

In a non-limiting embodiment, the closure device can be designed for connecting an electric assembly with an electric bicycle (e-bike). For example, a battery assembly, for example in the form of a so-called range extender, can be connected to a bicycle frame of a bicycle via the closure device.

In a non-limiting embodiment, a bicycle includes a closure device as described above, wherein the closure device is designed for connecting an assembly to a bicycle frame. The assembly for example can be designed by a battery assembly.

Other applications are also conceivable. For example, when the closure device is used on a bicycle, an arbitrary assembly, for example a lock assembly, a container, a drinking bottle or a piece of baggage can be connected to a bicycle frame, a bicycle handlebar or a bicycle rack via the closure device.

### BRIEF DESCRIPTION OF THE DRAWINGS

The idea underlying the solution will be explained in detail below with reference to the exemplary and non-limiting embodiments illustrated in the Figures:

FIG. 1 is a perspective exploded view of an exemplary and non-limiting embodiment of a closure device comprising a first closure part and a second closure part, which can be attached to each other along a closing direction;

FIG. 2 is another perspective exploded view;

FIG. 3A is a perspective view of the closure device before closing;

FIG. 3B is a perspective view of the closure device before closing, from below;

FIG. 3C is a frontal view of the arrangement as shown in FIG. 3A;

FIG. 3D is a top view of the arrangement as shown in FIG. 3A;

FIG. 3E is a sectional view along line A-A as shown in FIG. 3D;

FIG. 3F is a sectional view along line B-B as shown in FIG. 3D;

FIG. 3G is a side view of the closure device;

FIG. 3H is a sectional view along line C-C as shown in FIG. 3G;

FIG. 3I is a sectional view along line D-D as shown in FIG. 3H;

FIG. 4A is a perspective view of the closure device on closing;

FIG. 4B is a perspective view of the closure device before closing, from below;

FIG. 4C is a frontal view of the arrangement as shown in FIG. 4A;

FIG. 4D is a top view of the arrangement as shown in FIG. 4A;

FIG. 4E is a sectional view along line A-A as shown in FIG. 4D;

FIG. 4F is a sectional view along line B-B as shown in FIG. 4D;

FIG. 4G is a side view of the closure device;

FIG. 4H is a sectional view along line C-C as shown in FIG. 4G;

FIG. 4I is a sectional view along line D-D as shown in FIG. 4H;

FIG. 5A is a perspective view of the closure device on further closing, when a drive element is rotated for adjusting adjusting elements of the first closure part;

FIG. 5B is a perspective view of the closure device before closing, from below;

FIG. 5C is a frontal view of the arrangement as shown in FIG. 5A;

FIG. 5D is a top view of the arrangement as shown in FIG. 5A;

FIG. 5E is a sectional view along line A-A as shown in FIG. 5D;

FIG. 5F is a sectional view along line B-B as shown in FIG. 5D;

FIG. 5G is a side view of the closure device;

FIG. 5H is a sectional view along line C-C as shown in FIG. 5G;

FIG. 5I is a sectional view along line D-D as shown in FIG. 5H;

FIG. 6A is a perspective view of the closure device in a closed position after rotating the adjusting elements of the first closure part;

FIG. 6B is a perspective view of the closure device before closing, from below;

FIG. 6C is a frontal view of the arrangement as shown in FIG. 6A;

FIG. 6D is a top view of the arrangement as shown in FIG. 6A;

FIG. 6E is a sectional view along line A-A as shown in FIG. 6D;

FIG. 6F is a sectional view along line B-B as shown in FIG. 6D;

FIG. 6G is a side view of the closure device;

FIG. 6H is a sectional view along line C-C as shown in FIG. 6G;

FIG. 6I is a sectional view along line D-D as shown in FIG. 6H;

FIG. 7 is a sketch for illustrating a bearing opening eccentric with respect to a plug opening;

FIG. 8A is a sketch representing an eccentrically mounted adjusting element in a first position.

FIG. 8B is a sketch representing an eccentrically mounted adjusting element in a second position;

FIG. 9 is a view of an exemplary and non-limiting embodiment of a plug opening at the housing part of the first closure part;

FIG. 10A is a view representing an eccentrically mounted adjusting element in a first position relative to the plug opening as shown in FIG. 9;

FIG. 10B is a sketch representing the eccentrically mounted adjusting element in a second position relative to the plug opening as shown in FIG. 9;

FIG. 11A is a view representing an eccentrically mounted adjusting element in a first position relative to the plug opening, according to another exemplary and non-limiting embodiment;

FIG. 11B is a sketch representing the eccentrically mounted adjusting element as shown in FIG. 11A in a second position relative to the plug opening;

FIG. 12A is a view of in turn another exemplary and non-limiting embodiment of closure parts each with an electrical contact arrangement arranged thereon;

FIG. 12B is a side view of the arrangement as shown in FIG. 12A; and

FIG. 12C is a longitudinal sectional view through the closure device.

### DETAILED DESCRIPTION

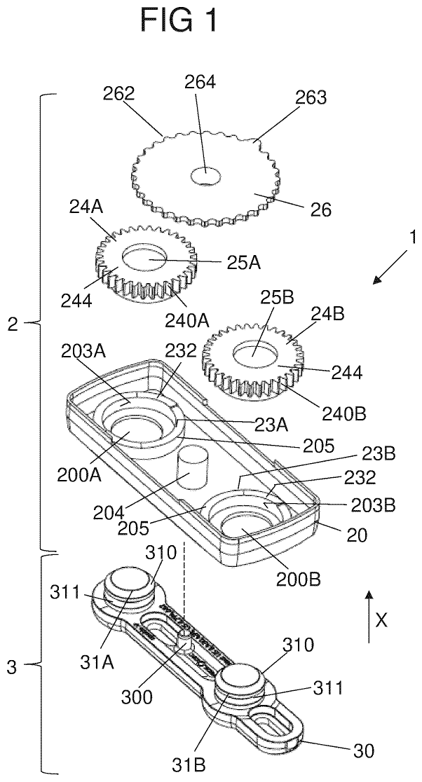

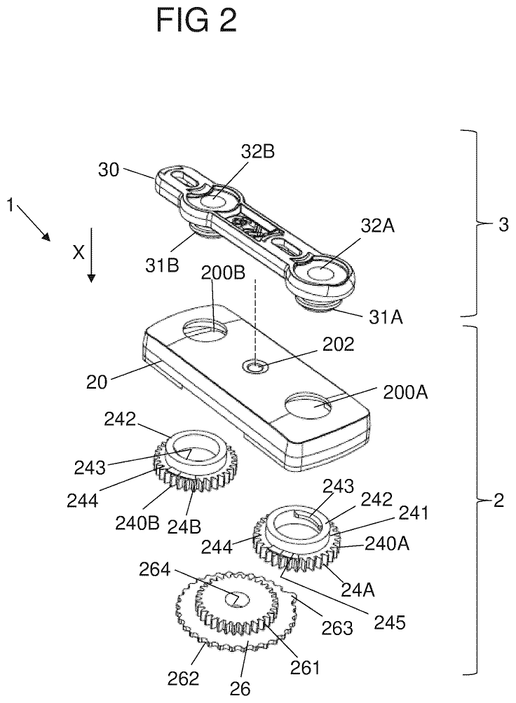

FIGS. 1 and 2 show an exemplary and non-limiting embodiment of a closure device 1 which includes two closure parts 2, 3 that can be attached to each other along a closing direction X and in a closed position of the closure device 1 are connected to each other such that the closure parts 2, 3 are fixed relative to each other along the closing direction X and in particular cannot easily, at least not without releasing the connection, be removed from each other against the closing direction X.

A first closure part 2 includes a housing part 20 which forms plug openings 200A, 200B for plugging in engaging elements 31A, 31B of a second closure part 3 formed on a housing 30. The engaging elements 31A, 31B can be plugged into the plug openings 200A, 200B along the plugging direction X so as to connect the closure parts 2, 3 to each other.

Within the housing part 20 adjusting elements 24A, 24B each are rotatably mounted in a bearing opening 203A, 203B, which is formed by a bearing collar 205 formed within the housing part 20. On each plug opening 200A, 200B a bearing collar 205 is formed for forming the respectively associated bearing opening 203A, 203B for supporting the adjusting element 24A, 24B.

The adjusting elements 24A, 24B of the first closure part 2 each are formed by a base 244 from which a rigid collar portion 242 protrudes along the closing direction X. On the collar portion 242 there is each formed an engaging protrusion 243 which protrudes from the (rigid) collar portion 242 radially to the inside.

The collar portion 242 of each adjusting element 24A, 24B forms a receptacle for receiving an associated engaging element 31A, 31B of the second closure part 3 and in the illustrated exemplary and non-limiting embodiment has a ring shape which circularly extends on the base 244. The base 244 here forms an abutment surface with which the respectively associated engaging element 31A, 31B of the second closure part 3 can come into abutment in a closed position of the closure device 1.

The adjusting elements 24A, 24B each are rotatably mounted in the associated bearing opening 203A, 203B of the housing part 20 and thus are rotatable relative to the housing part 20. As will yet be explained below, the adjusting elements 24A, 24B are adjustable on the housing part 20 between a first position and a second position. In the first position of the adjusting elements 24A, 24B the second closure part 3 can be plugged into the plug openings 200A, 200B with the engaging elements 31A, 31B so that the closure parts 2, 3 can be connected to each other. In the second position, the adjusting elements 24A, 24B block an opening of the closure device 1.

In the illustrated exemplary and non-limiting embodiment, a bearing pin 300 is formed on the housing 30 of the second closure part 3, which on attachment of the closure parts 2, 3 to each other comes into engagement with an engagement opening 202 on the housing part 20 of the first closure part 2. Via the engagement of the bearing pin 300 into the engagement opening 202 the closure parts 2, 3 are mounted on each other and thereby supported in a defined position relative to each other, when the closure parts 2, 3 are attached to each other.

As this can be taken for example from FIG. 2, the engaging elements 31A, 31B are formed as trunnions on the housing 30 of the second closure part 3. On a shank portion 311 a circumferentially extending engaging protrusion 310 is formed, which in the closed position of the closure device 1 is in engagement with the engaging protrusion 243 of the associated adjusting element 24A, 24B of the first closure part 2, so that via the engagement the closure parts 2, 3 are positively held at each other along the closing direction X.

On a bearing element 204 of the housing part 20 of the first closure part 2 (which in its interior forms the engagement opening 202) a drive element 26 is rotatably mounted, which includes a circumferential toothing 261. The adjusting elements 24A, 24B each include a toothing portion 240A, 240B on an outer circumference of the base 244, via which the respective adjusting element 24A, 24B is in meshing engagement with the toothing 261 on the drive element 26. The drive element 26 is rotatably mounted on the bearing element 204 of the housing part 20 via a bearing opening 264 and with a fluted, circumferential actuating portion 262 protrudes from the housing part 20 to the outside, so that the drive element 26 can be manually actuated by a user.

By rotating the drive element 26, the adjusting elements 24A, 24B can jointly and preferably synchronously be rotated on the housing part 20 between a first position and a second position. An indicating element 263 in the form of an indicating nose on the outer circumference of the drive element 26 indicates to a user in what position the drive element 26 and thus the adjusting elements 24A, 24B are disposed.

In the exemplary and non-limiting embodiment shown in FIGS. 1 and 2, the plug openings 200A, 200B are formed by at least approximately circular openings on an upper side of the housing part 20. The engaging elements 31A, 31B can be inserted into the plug openings 200A, 200B along the closing direction X in order to close the closure device 1, wherein in a closed position engaging protrusions 310 on shank portions 311 of the engaging elements 31A, 31B are in engagement with engaging protrusions 243 on collar portions 242 of the adjusting elements 24A, 24B and the closure parts 2, 3 thereby are fixed relative to each other along the closing direction X. For opening the closure device 1, the engagement between the engaging protrusions 243, 310 can be released so that the closure parts 2, 3 can be separated from each other against the closing direction X by removing the engaging elements 31A, 31B out of the plug openings 200A, 200B.

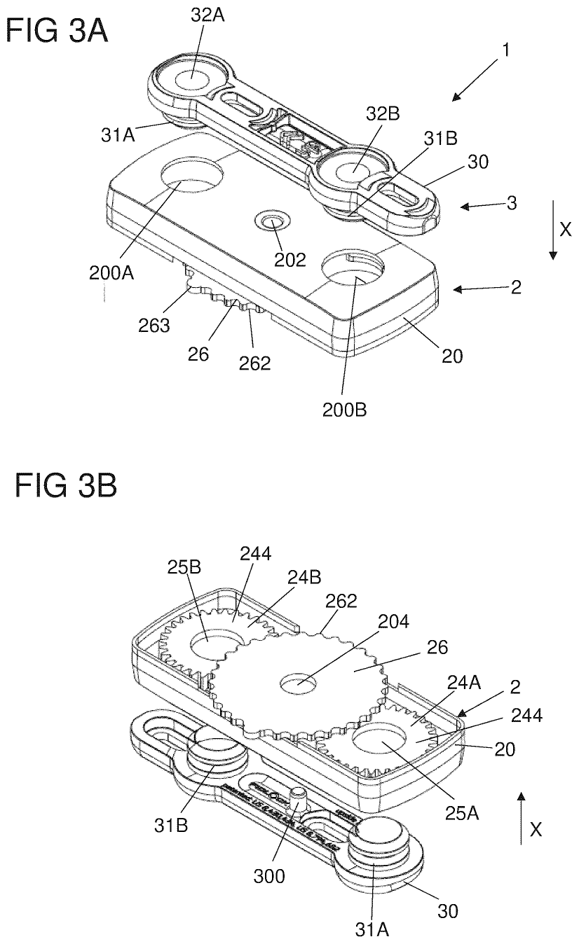

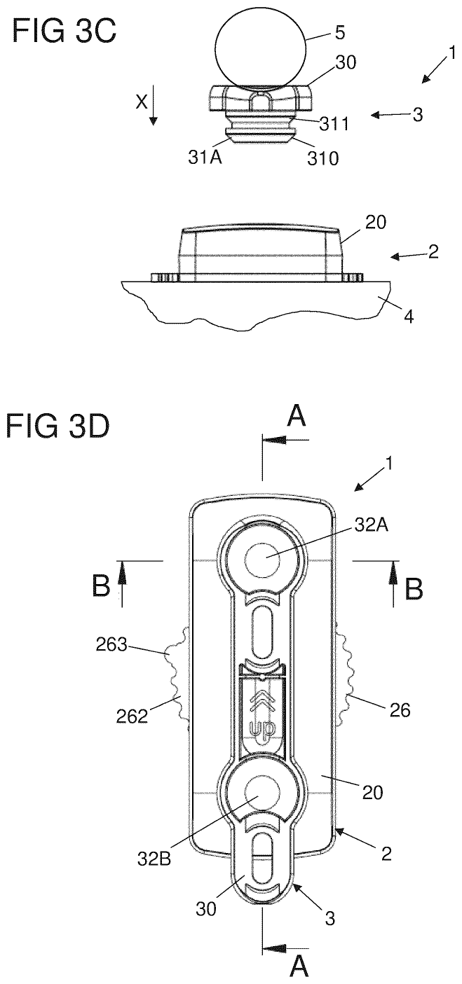

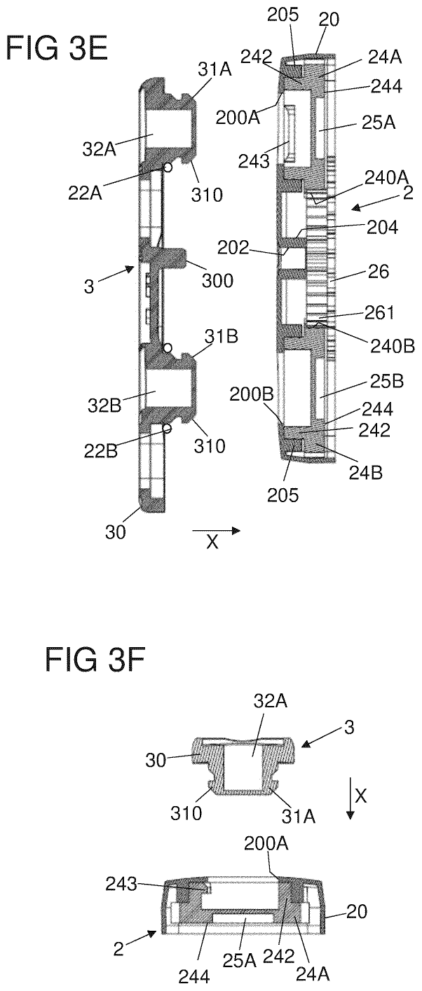

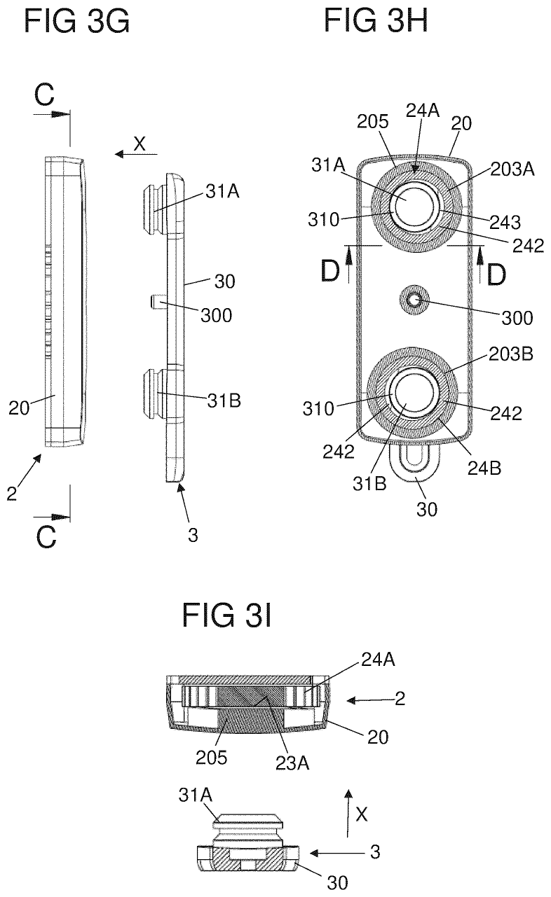

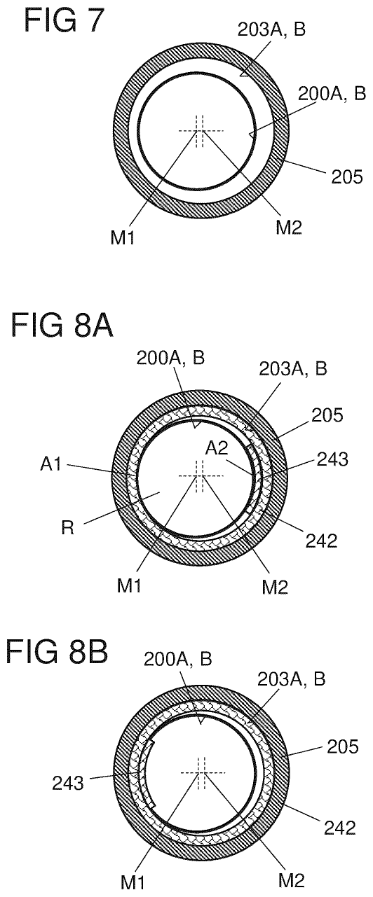

Via the collar portion 242, each adjusting element 24A, 24B is received in the associated bearing opening 203A, 203B of the housing part 20 and thereby is rotatably mounted on the housing part 20. As this can be taken for example from FIG. 3H in a synopsis with the sketches as shown in FIG. 7 and FIGS. 8A, 8B, each adjusting element 24A, 24B here is mounted eccentrically relative to the respectively associated plug opening 200A, 200B, so that the rotary movement of the adjusting element 24A, 24B is effected eccentrically relative to the plug opening 200A, 200B.

This is illustrated in FIG. 7 and FIGS. 8A, 8B.

Each plug opening 200A, 200B includes a center M1, which is formed by the center of the plug opening 200A, 200B. In the plugged position, the associated engaging element 31A, 31B of the second closure part 3 is inserted into the plug opening 200A, 200B concentrically to this center M1.

The rotary support of the adjusting element 24A, 24B here is eccentric relative to the center M1 of the plug opening 200A, 200B. The adjusting element 24A, 24B is rotatably mounted about an axis of rotation M2, which in a plane perpendicular to the closing direction X is spaced apart from the center M1, as this can be taken from FIG. 7 and FIGS. 8A, 8B.

Due to the eccentric support, the adjusting element 24A, 24B in its first position takes such a position relative to the plug opening 200A, 200B that the engaging protrusion 243 does not protrude into the region of the plug opening 200A, 200B (as seen along the drawing plane perpendicular to the closing direction X as shown in FIGS. 8A, 8B), as this can be taken from FIG. 8A. By rotating the adjusting element 24A, 24B, the engaging protrusion 243 is moved relative to the plug opening 200A, 200B and in the second position as shown in FIG. 8B protrudes radially to the inside into the plug opening 200A, 200B, so that the engaging protrusion 243 is in engagement with the engaging protrusion 310 of the engaging element 31A, 31B and the engaging element 31A, 31B thus is positively fixed to the first closure part 2 along the closing direction X.

The adjustment of the adjusting elements 24A, 24B in the illustrated exemplary and non-limiting embodiment is effected manually by a user by actuating the drive element 26. In the first position (FIG. 8A) the engaging elements 31A, 31B can be inserted into the plug openings 200A, 200B at the housing 20. By transferring the adjusting elements 24A, 24B, a user then can block the closure device 1 so that in the second position of the adjusting elements 24A, 24B the engaging elements 31A, 31B are blocked in the plug openings 200A, 200B and the closure parts 2, 3 thus are held at each other.

FIGS. 3A-31 show the closure device 1 before closing. The closure parts 2, 3 are attached to each other along the closing direction X so that the engaging elements 31A, 31B thereby are introduced into the plug openings 200A, 200B. The adjusting elements 24A, 24B here are disposed in their first position (corresponding to the position as shown in FIG. 8A).

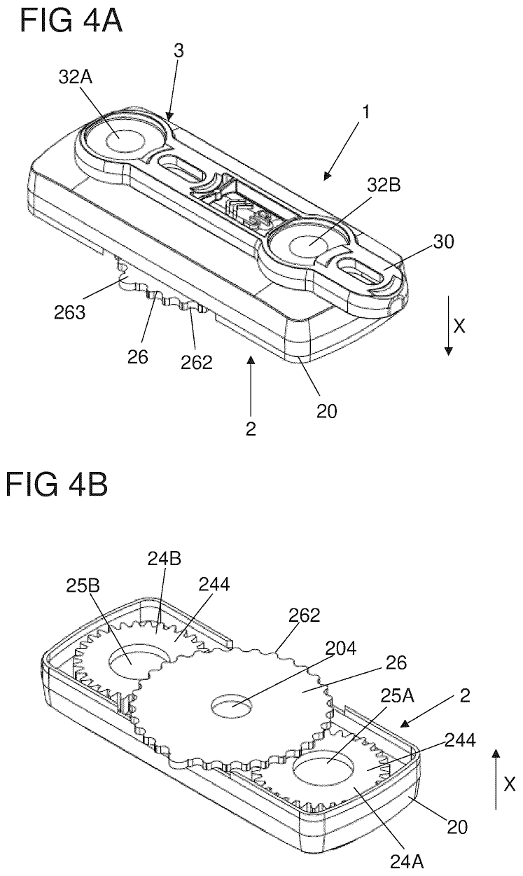

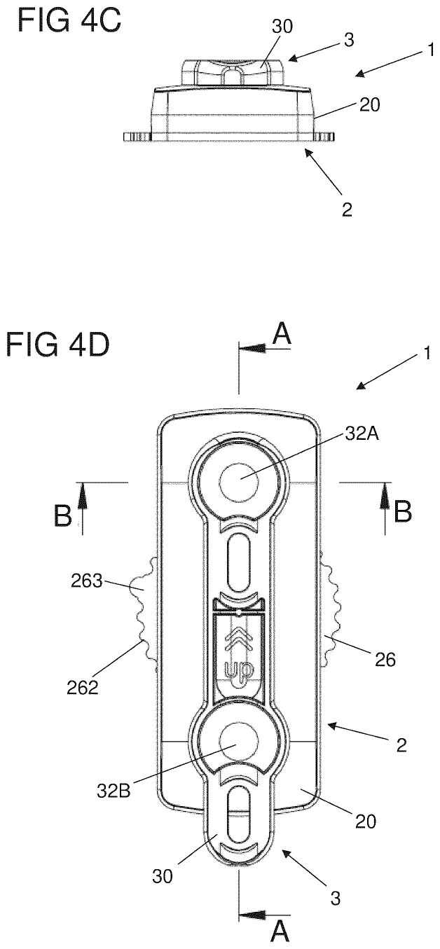

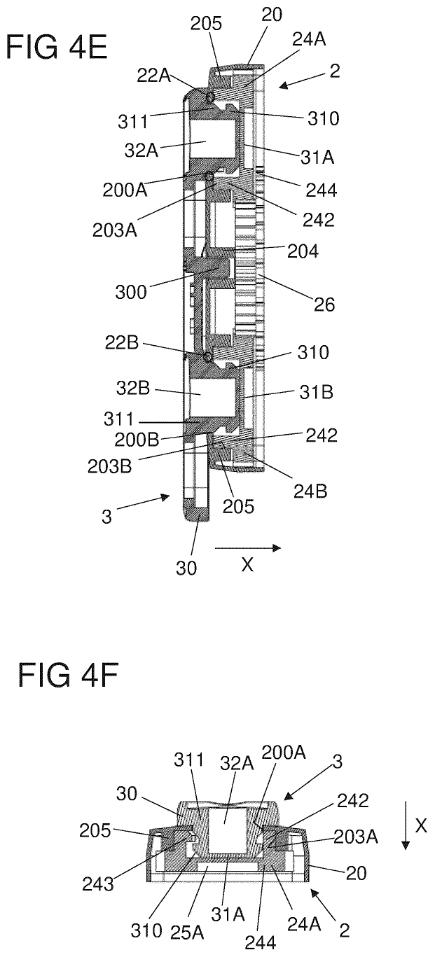

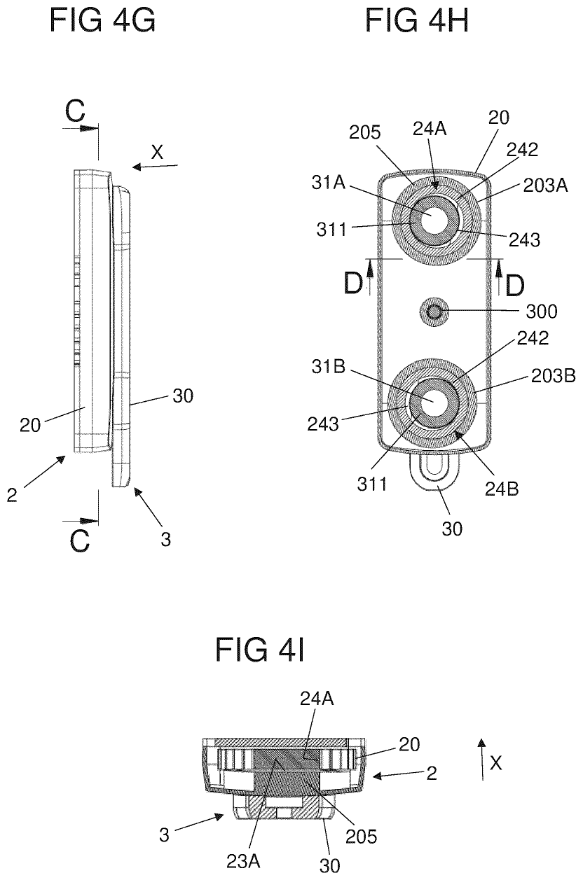

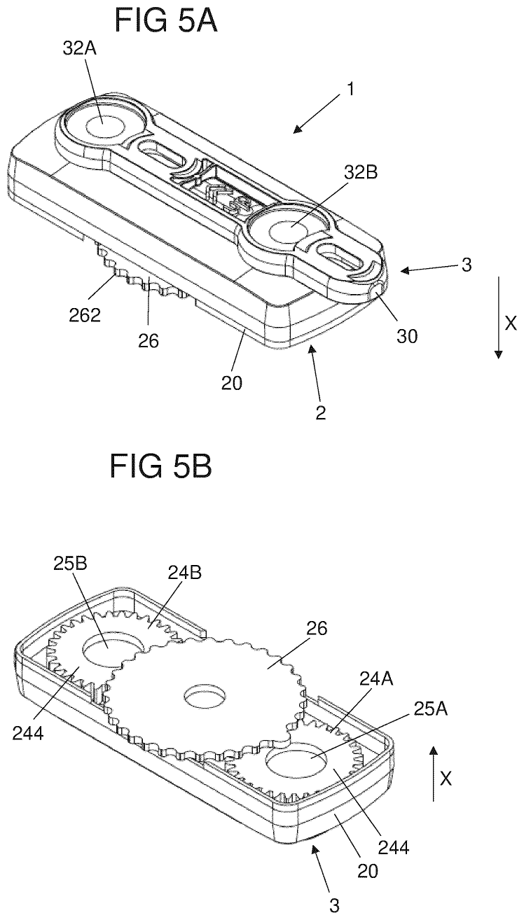

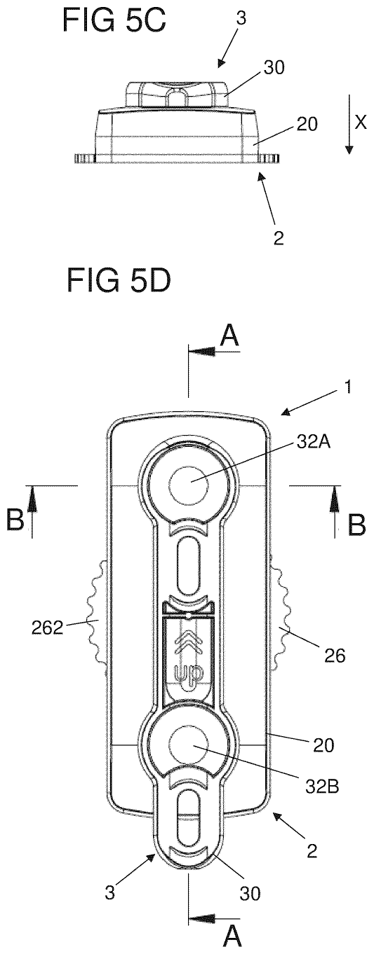

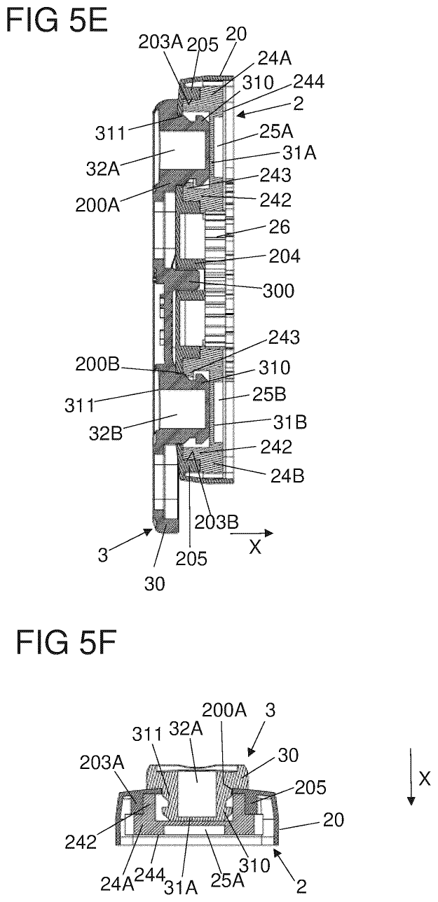

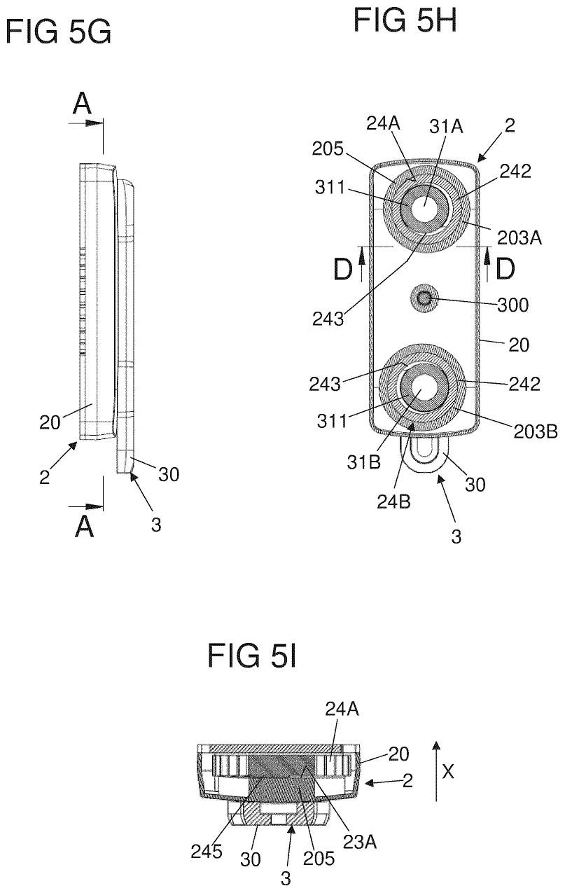

When the engaging elements 31A, 31B have been inserted into the plug openings 200A, 200B, as this can be taken from FIGS. 4A-41, a user can rotate the drive element 26 in that the user for example moves the drive element 26 with his fingers. The adjusting elements 24A, 24B thereby are rotated on the housing part 20, as this can be taken from FIGS. 5A-51.

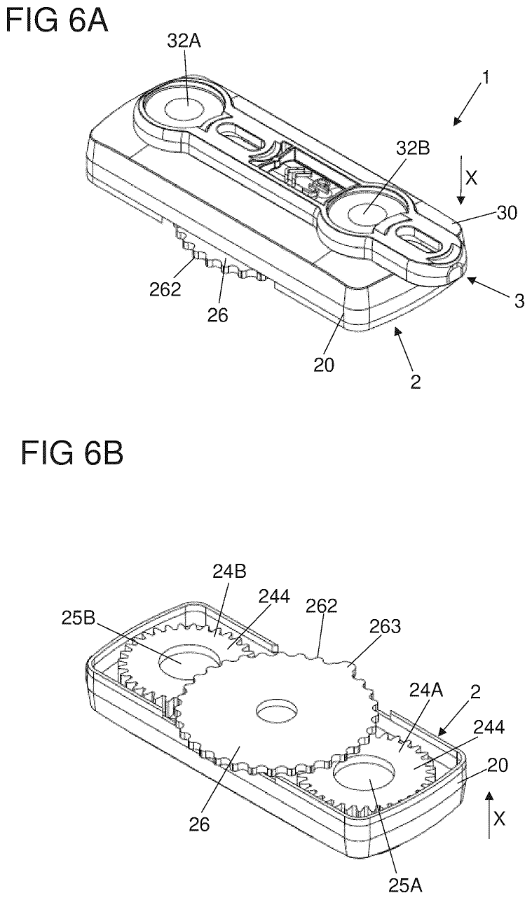

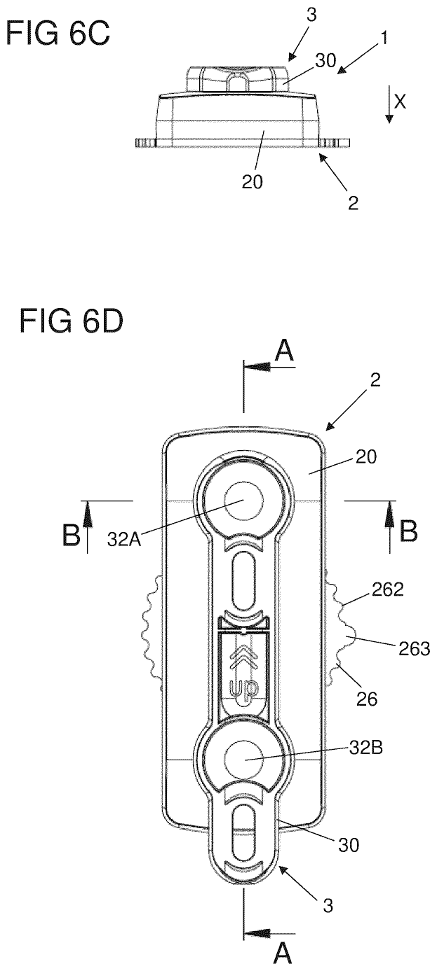

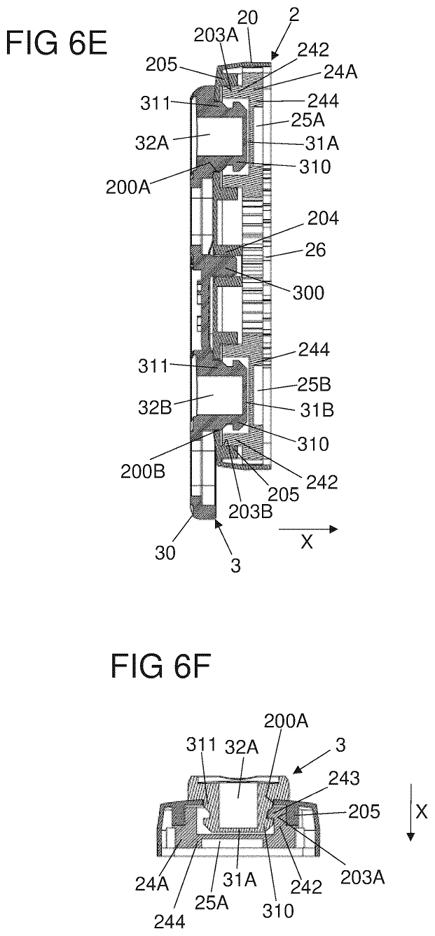

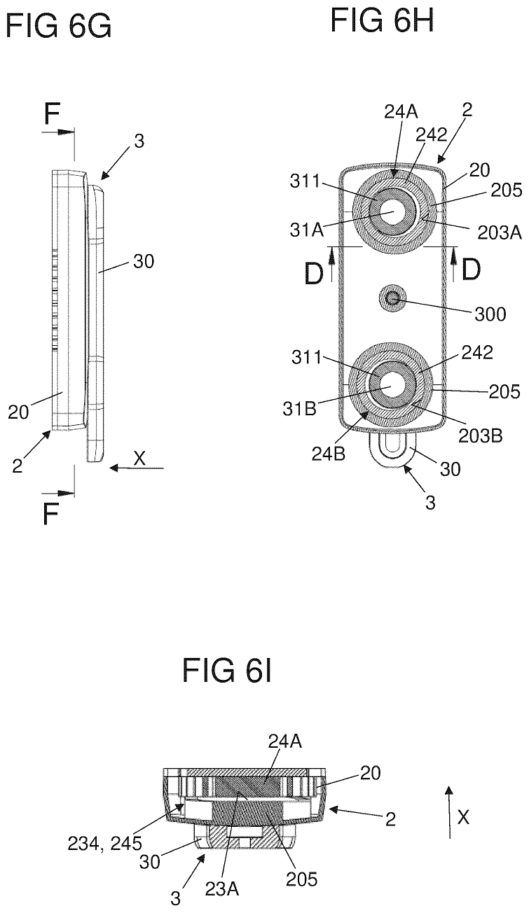

FIGS. 6A-61 show the closure device 1 in the closed position in which the adjusting elements 24A, 24B are rotated on the housing part 20 such that the adjusting elements 24A, 24B take the position as shown in FIG. 8B and thus produce the engagement with the engaging elements 31A, 31B. The closure parts 2, 3 thus are held at each other along the closing direction X and cannot easily be released from each other, in any case not without moving the adjusting elements 24A, 24B back into the first position.

For opening the closure device 1, the adjusting elements 24A, 24B are rotated from the second position (FIGS. 20A-201) back into the first position (FIGS. 3A-31) so that the engagement of the engaging protrusions 243, 310 is eliminated and the closure parts 2, 3 can be removed from each other along the closing direction X.

The adjusting elements 24A, 24B are also axially adjusted on the housing part 20 when rotated from the first position into the second position. For this purpose, run-up portions 241 with ramp portions 245 are formed on the adjusting elements 24A, 24B, as this can be taken from FIG. 2, which on rotation of the adjusting elements 24A, 24B slide on run-up elements 23A, 23B which are formed integrally on the end faces of the bearing collars 205, as this can be taken from the perspective exploded views as shown in FIGS. 1 and 2.

As can be taken from the sectional view as shown in FIG. 3E, the adjusting elements 24A, 24B in their first position are axially approached to the bearing collars 205. On rotation, the run-up portions 241 with the ramp portions 245 formed thereon run up on associated ramp portions 232 on the run-up elements 23A, 23B so that in the second position the adjusting elements 24A, 24B are axially away from the bearing collars 205 by a certain distance, as this can be taken from the sectional view as shown in FIG. 6E.

As schematically indicated in FIG. 3E, an elasticity element 22A, 22B for example in the form of an elastically deformable ring element can be arranged for example on each engaging element 31A, 31B. When the adjusting elements 24A, 24B are axially adjusted on the housing part 20 when rotated into the second position, the engaging elements 31A, 31B are drawn into the plug openings 200A, 200B in the closing direction X, so that the elasticity elements 22A, 22B come into abutment with the upper side of the housing part 20 under an elastic bracing, and the closure parts 2, 3 thus are elastically braced relative to each other.

On each run-up element 23A, 23B and the respectively associated run-up portion 241 ramp portions 232, 245 are formed, which on rotation of the adjusting element 24A, 24B slide on each other and thus effect an axial change in position of the respective adjusting element 24A, 24B along the closing direction X relative to the housing part 20. In cooperation with the respective elasticity element 22A, 22B the adjusting elements 24A, 24B are adjusted in this way and effect an elastic pretension at the engaging elements 31A, 31B so that the closure parts 2, 3 are elastically pretensioned relative to each other and thus are fixed relative to each other in a clearance-free and rattle-free way by compensating manufacturing and assembly tolerances.

The first closure part 2 includes magnetic elements 25A, 25B which are arranged on the adjusting elements 24A, 24B. On the second closure part 3 magnetic elements 32A, 32B are arranged on the engaging elements 31A, 31B. The magnetic elements 25A, 25B, 32A, 32B cooperate in a magnetically attracting manner and in this way support the attachment of the closure parts 2, 3 to each other along the closing direction X.

For closing the closure device 1 the closure parts 2, 3 are attached to each other along the closing direction X. As this is schematically shown in FIG. 3C, the closure parts 2, 3 here are associated to different assemblies 4, 5 so that by connecting the closure parts 2, 3 the assemblies 4, 5 can be connected to each other.

What is decisive for connecting here is a relative movement between the closure parts 2, 3. It is, however, not essential whether one of the closure parts 2, 3 remains stationary during the closing operation and merely the other closure part 3, 2 is moved, or whether both closure parts 2, 3 are moved towards each other.

For example, the closure part 3 can be stationarily fixed to an associated assembly 5, for example a bicycle frame, so that by attaching the other closure part 2, the associated assembly 4 can be fixed to the assembly 5.

In the exemplary and non-limiting embodiment described above, each plug opening 200A, 200B is of circular design (as seen along a plane perpendicular to the closing direction X). In this case, as indicated in FIG. 8A, each plug opening 200A, 200B defines a space R into which the respectively associated engaging element 31A, 31B of the second closure part 3 can be inserted along the closing direction X. The plug opening 200A, 200B here is delimited by its circumferential, round edge which forms boundary portions A1, A2 facing each other, between which the engaging element 31A, 31B can be inserted for closing the closure device 1 and between which the center M1 is centrally arranged.

The plug opening 200A, 200B is not necessarily circular, but in principle can be defined by an arbitrary opening cross-section.

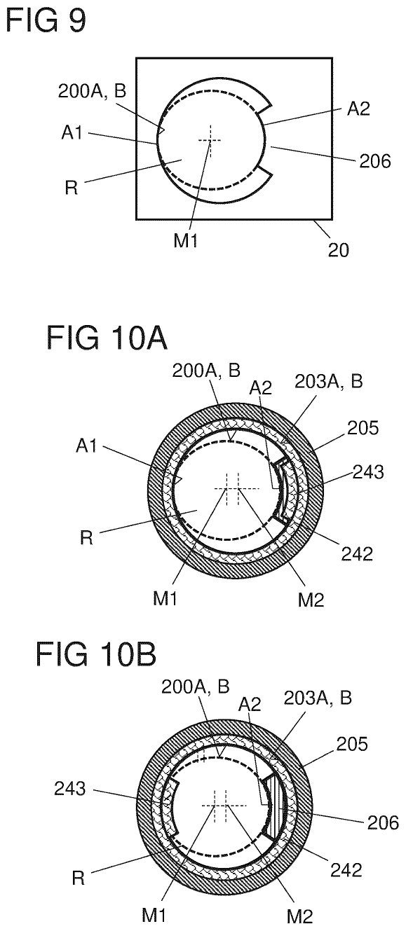

This is illustrated in FIG. 9. For example, the plug opening 200A, 200B can be defined by an opening contour in which a protrusion 206 protrudes radially to the inside from a basically circular basic shape. The protrusion 206 forms a boundary portion A2 which faces a boundary portion A1 formed by the (otherwise) circular contour of the plug opening 200A, 200B, so that for insertion into the plug opening 200A, 200B the engaging element 31A, 31B can be inserted into a space R located between the boundary portions A1, A2.

The space R includes a center M1 which is located centrally between the boundary portions A1, A2. On insertion into the plug opening 200A, 200B, the associated engaging element 31A, 31B is introduced into the plug opening 200A, 200B substantially concentrically to this center M1.

As this is shown in FIGS. 10A and 10B, the adjusting element 24A, 24B is mounted eccentrically to the center M1 about an axis of rotation M2. In the first position of the adjusting element 24A, 24B (FIG. 10A) the engaging protrusion 243 on the collar portion 242 is located below the protrusion 206 so that the engaging protrusion 243 is arranged outside the space R (as seen along the radial plane perpendicularly to the closing direction X) and thus does not limit the space R. In the second position on the other hand (FIG. 10B) the adjusting element is rotated such that the engaging protrusion 243 is arranged in the region of the boundary portion A1 and protrudes radially into the space R. The engaging protrusion 243 protrudes into the space R and within the space R is in engagement with the engaging protrusion 310 on the engaging element 31A, 31B.

In the illustrated exemplary and non-limiting embodiments, the engaging protrusion 243 represents an acting portion of the adjusting element 24A, 24B, which in the second position of the adjusting element 24A, 24B produces the connection between the closure parts 2, 3.

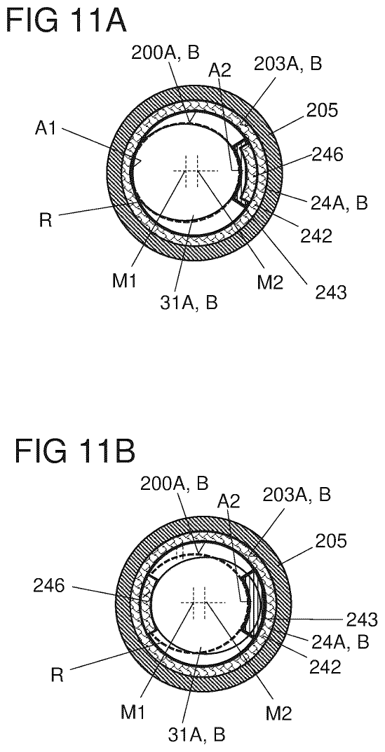

It is also conceivable, however, that the engaging protrusion 243 is not arranged on the adjusting element 24A, 24B and is adjustable jointly with the adjusting element 24A, 24B, but on the housing part 20, as this is schematically shown in FIGS. 11A and 11B. The engaging protrusion 243 in this case is formed by a protrusion formed stationarily on the housing part 20, which protrudes radially to the inside. On the adjusting element 24A, 24B, an acting portion 246 in this case is formed for example on the collar portion 242, which on rotation of the adjusting element 24A, 24B is operatively connected to the engaging element 31A, 31B and thereby urges the engaging element 31A, 31B into engagement with the engaging protrusion 243 transversely to the closing direction X, as this is shown at the transition from FIG. 11A towards FIG. 11B. In the second position of the adjusting element 24A, 24B, the engaging element 31A, 31B is offset (to the right in the representation of FIG. 11B) and thereby moved into engagement with the engaging protrusion 243 at the housing part 20. In this case, the adjusting element 24A, 24B does not produce the (positive) connection on its own, but urges the engaging element 31A, 31B into engagement with the engaging protrusion 243 at the housing part 20 for producing the positive connection or at least secures the connection (for the case that the engaging element 31A, 31B has already been moved into engagement with the engaging protrusion 243 at the housing part 20 due to the magnetic interaction).

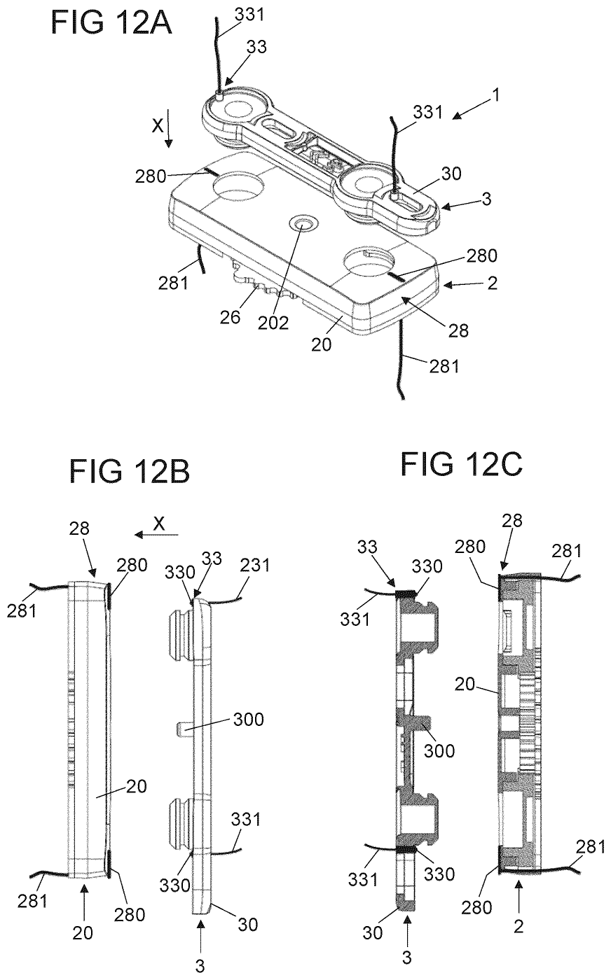

In the exemplary and non-limiting embodiments described above, the closure device 1 can be configured as an electrical closure device with electrical contacts so that when the closure parts 2, 3 are connected, there is (also) produced an electrical connection. This is illustrated with reference to FIGS. 12A-12C.

The exemplary and non-limiting embodiment as shown in FIGS. 12A-12C functionally corresponds to the exemplary and non-limiting embodiment of the closure device 1 as shown in FIGS. 1 to 8A, 8B, so that for the functional configuration of the closure device 1 reference is made to the preceding explanations.

In the illustrated exemplary and non-limiting embodiment contact arrangements 28, 33 additionally are arranged on the closure parts 2, 3, which are formed by contact elements 280, 330 on the respective housing parts 20, 30. When the closure parts 2, 3 are attached to each other along the closing direction X for closing the closure device 1, the contacts 28, 33 come into electric contact with each other so that (in the illustrated exemplary and non-limiting embodiment) a two-pole electrical connection is produced between the contact arrangements 28, 33. Lines 281, 331 thus are electrically connected to each other, so that currents can be transmitted, for example for transmitting control signals or an electric supply current.

There can be provided an arbitrary number of electrical contacts 280, 330, for example two, three, four, seven or also even more contacts.

The idea underlying the solution is not limited to the exemplary and non-limiting embodiments described above but can also be realized in a different way.

A closure device as described above can be used for example on a vehicle, for example on a bicycle, such as an electrically driven bicycle (e-bike).

For example, a closure device as described above can be used for connecting an electrical assembly to a bicycle frame, for example for releasably connecting a battery arrangement to the bicycle frame.

Like in the illustrated exemplary and non-limiting embodiments, the closure device can be configured as a magnetic closure device with magnetic elements. It is also conceivable, however, to configure the closure device as a purely mechanical closure device by omitting the magnetic elements.

1. A closure device for connecting two assemblies to each other, comprising
a first closure part associated to a first one of the assemblies, which comprises a housing part, a plug opening arranged on the housing part, at least one first engaging protrusion and an adjusting element adjustably arranged on the housing part, and
a second closure part associated to a second one of the assemblies, which comprises an engaging element with at least one second engaging protrusion,
wherein the engaging element can be inserted into the plug opening along a closing direction for closing the closure device, in a closed position the at least one first engaging protrusion is in engagement with the at least one second engaging protrusion for holding the first closure part and the second closure part at each other against the closing direction, and the first closure part and the second closure part can be separated from each other for opening the closure device,
wherein the plug opening, as seen along a plane perpendicular to the closing direction, is delimited by at least one boundary portion in such a way that for closing the closure device the engaging element can be inserted into a space delimited by the at least one boundary portion, wherein in the first position an acting portion of the adjusting element is arranged outside the space in order to provide for an insertion of the engaging element into the space, wherein the adjusting element, when the first closure part and the second closure part are attached to each other, can be transferred from the first position into the second position so that in the second position the acting portion, as seen along the plane perpendicular to the closing direction, is arranged within the space in order to produce or secure the engagement between the at least one first engaging protrusion and the at least one second engaging protrusion for holding the first closure part and the second closure part at each other against the closing direction.

2. The closure device according to claim 1, wherein the space delimited by the at least one boundary portion comprises a center and the adjusting element can be rotated relative to the housing part of the first closure part about an axis of rotation offset from the center between a first position and a second position.

3. The closure device according to claim 2, wherein the space is delimited by two boundary portions facing each other, wherein the center is arranged centrally between the boundary portions.

4. The closure device according to claim 1, wherein the at least one first engaging protrusion is arranged on the adjusting element and can be rotated relative to the housing part jointly with the adjusting element.

5. (canceled)

6. The closure device according to claim 1, wherein the adjusting element comprises a base and a collar portion rigidly formed on the base, which protrudes from the base along the closing direction.

7. The closure device according to claim 6, wherein at least one of: the collar portion forms the acting portion; and the at least one first engaging protrusion is arranged on the collar portion.

8. (canceled)

9. (canceled)

10. The closure device according to claim 1, wherein at least one of
in the closed position the at least one first engaging protrusion and the at least one second engaging protrusion positively are in engagement with each other,
the plug opening is formed by a circular opening,
the housing part comprises a bearing opening for rotatably supporting the adjusting element on the housing part about the axis of rotation, and
for closing the closure device, the first closure part and the second closure part can be attached to each other exclusively in the first portion of the adjusting element.

11. (canceled)

12. (canceled)

13. (canceled)

14. The closure device according to claim 1, wherein the adjusting element in the second position is configured to exert a pretensioning force on the engaging element along the closing direction.

15. The closure device according to claim 1, wherein in the first position the adjusting element takes a first axial position relative to the housing part and in the second position takes a second axial position relative to the housing part, which is different from the first axial position and offset along the closing direction, in order to exert a pretensioning force on the engaging element in the second position along the closing direction.

16. The closure device according to claim 1, wherein the first closure part comprises a run-up element with a first ramp portion, which is arranged on the housing part, and the adjusting element comprises a run with a second ramp portion, wherein during an adjustment of the adjusting element for axially adjusting the adjusting element the first ramp portion slides on the second ramp portion.

17. The closure device according to claim 16, wherein the run-up element is non-rotatably connected to the housing part.

18. The closure device according to claim 16, wherein at least one of the first closure part and the second closure part comprises an elasticity element elastically deformable along the closing direction, which is elastically deformable on axial adjustment of the adjusting element.

19. The closure device according to claim 18, wherein the elasticity element is formed by an element formed of an elastomeric material or by a mechanical spring element.

20. The closure device according to claim 1, wherein the first closure part comprises a drive element operatively connected to the adjusting element and to be actuated by a user, which is configured to introduce an adjusting force into the adjusting element on actuation.

21. The closure device according to claim 20, wherein at least one of: of the drive element is rotatably arranged on the housing part; and the drive element comprises a toothing portion which is in meshing engagement with a toothing portion of the adjusting element.

22. (canceled)

23. The closure device according to claim 1, wherein the first closure part comprises a first magnetic element and the second closure part comprises a second magnetic element, wherein the first magnetic element and the second magnetic element cooperate in a magnetically attracting manner in order to magnetically support the attachment of the first closure part and the second closure part for closing the closure device.

24. The closure device according to claim 1, wherein the first closure part comprises two slots with at least one first engaging protrusion each and an adjusting element rotatable relative to the housing part, wherein the second closure part comprises two engaging elements with at least one second engaging protrusion each, wherein for closing the closure device each of the engaging elements of the second closure part can be attached to one of the slots of the first closure part and in the closed position the first engaging protrusions are in engagement with the second engaging protrusions for holding the first closure part and the second closure part at each other against the closing direction.

25. The closure device according to claim 24, wherein the adjusting elements each are arranged on the housing part of the first closure part so as to be adjusted between a first position and a second position.

26. The closure device according to claim 24, wherein the adjusting elements are jointly adjustable via an actuating mechanism of the first closure part, or the adjusting elements are adjustable independently of each other.

27. (canceled)

28. The closure device according to claim 1, wherein the first closure part comprises a first electrical contact arrangement and the second closure part comprises a second electrical contact arrangement, wherein in the closed position the first electrical contact arrangement and the second electrical contact arrangement are operatively connected to each other in an electrically contacting way.
